(19) United States
(12) Patent Application Publication
(10) Pub. No.: US 2009/0180277 A1
(43) Pub. Date: Jul. 16, 2009

(54) NiteNob

(76) Inventor: Joseph F. Falce, Plainedge, NY (US)

Correspondence Address: JOSEPH F. FALCE, 71 WADSWORTH AVENUE, PLAINEDGE, NY, 11756, US

(21) Appl. No.: 12/008,811

(22) Filed: Jan. 14, 2008

(51) Int. Cl. E05B 17/10

(52) U.S. Cl. 362/100

(57) ABSTRACT

The NiteNob is a totally new take on an item taken for granted in every home or dwelling; the door knob. What makes the NiteNob stand out versus a standard door knob is the feature of a built in safety feature, the LED ring which allows the internal room side of the door knob to shine a dim light. The LED light which is emitted from the NiteNob can easily be located in a dark or smoke filled room allowing a person to quickly make their way toward the exit. In a non emergency situation the NiteNob assumes the docile role of reassuring night light which many people find soothing and comforting in an otherwise dark bedroom, hallway or bathroom.

The NiteNob was designed to immediately and permanently mark a method of egress from a dark or smoke filled room. The inventor reasoned that in an emergency or panic driven situation, the NiteNob will light the way to safety by directing a person to the exit by marking the inner door handle of a door knob with a red LED (Light Emitting Diode) light. With the clearly illuminated path to the exit, the person can swiftly approach the exit door, grasp the handle and twist to open as in any standard door knob. This split second identification and exit can easily mean the difference between life and death.

The inventor envisioned the NiteNob as a direct replacement to existing standard door knobs and also as a standard feature on new construction. The NiteNob would incorporate standard exterior locking mechanisms for keyed entry with standard internal twist locking mechanism, the difference being an LED illuminated ring in the perimeter of the inner door knob surrounding the room interior side of the door knob. Interior doors may have the NiteNob feature on both sides of the door knob or on the one side facing the fastest route to a safe exit.

### BACKGROUND OF THE INVENTION

I as the inventor feel that the NiteNob addresses a previously neglected peril which had existed, particularly in a dark and strange environment. An example being that of a hotel guest who is startled from a deep sleep and in his or her state of initial disorientation, they can scan the dark or smoke filled room and locate the illuminated NiteNob and make a swift and safe exit. The NiteNob is therefore a life saving device and should be endorsed as such.

### BRIEF SUMMARY OF THE INVENTION

The idea of the NiteNob was to improve on the standard door knob, to not only maintain it's recognized use of a mechanism for egress from a room, but to also add the safety feature of self-illumination for the purpose of exit during a power failure or escape during an emergency. The NiteNob, due to it's self illumination solves a previously existing problem of finding a door in a dark or smoke filled room. This in turn swiftly aids in identifying a means of exiting a room.

### BRIEF DESCRIPTION AND VIEWS(S)

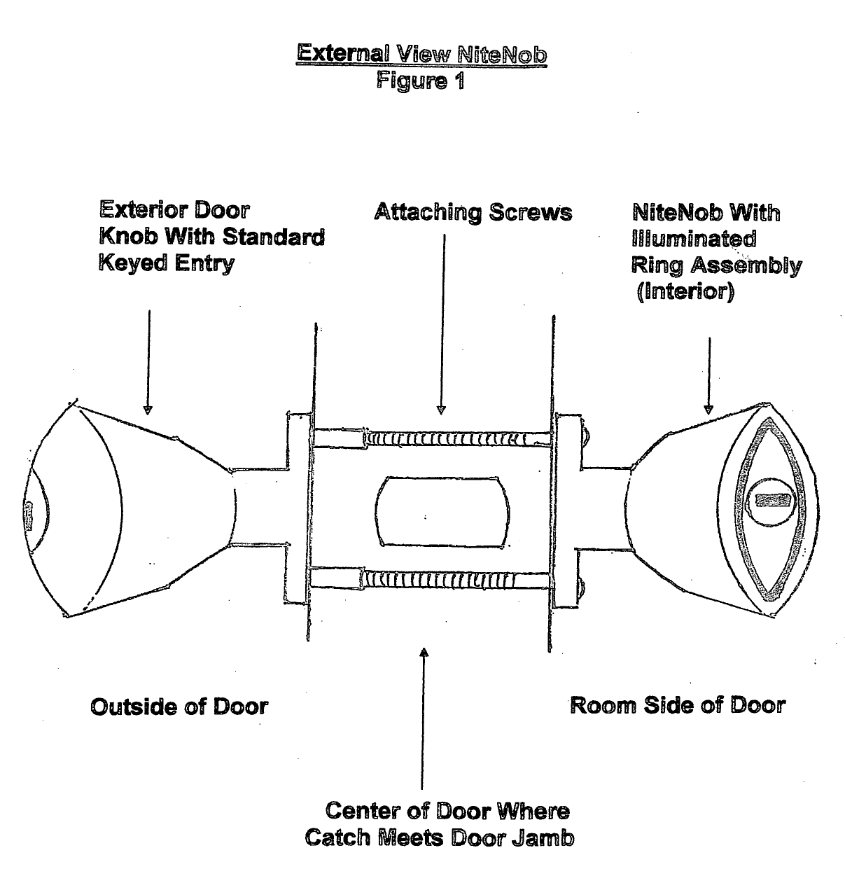

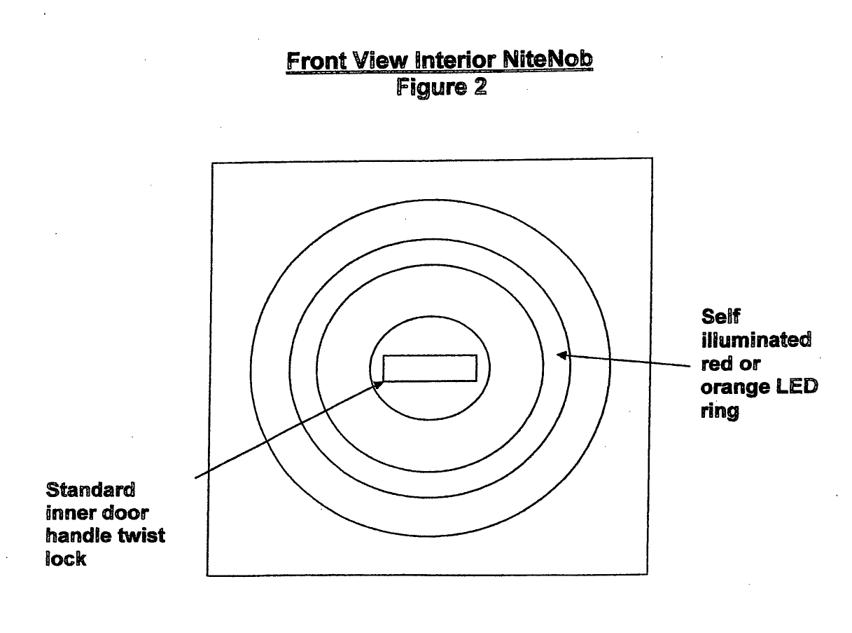

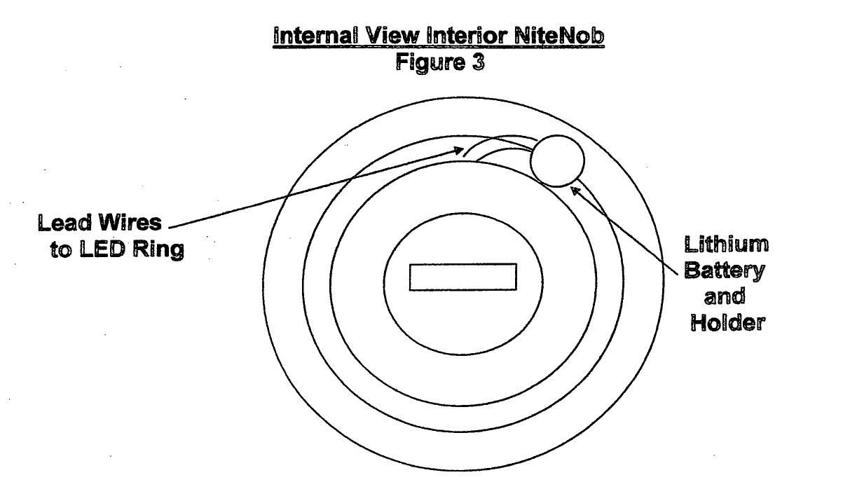

Please see separate sheets marked FIG. 1, FIG. 2 & FIG. 3.

### DETAILED DESCRIPTION OF THE INVENTION

The NiteNob differentiates itself from a conventional door knob in the respect that it not only works in the same mechanical fashion as the conventional door knob, but it also introduces the illuminated safety feature. The way it works is relatively simple. The standard design of a common door knob is utilized by using the existing unoccupied internal space on the internal, room side of the door knob to house it's components. The NiteNob consists of a medical or security designed lithium battery, a battery holder and simple lead wires connecting to the red or orange LED display ring.

1. What I claim as my invention is a distinct safety and precautionary improvement: on existing door knobs. The idea of the NiteNob was derived for the express purpose of clearly marking and ushering a unmistakable method of egress from a potentially life threatening environment; whether it be the unfamiliar surroundings of a dark hotel room, hospital room, nursing home or even your own dark or smoke filled bedroom. I feel the NiteNob will no doubt be as effective and reliable as smoke detectors have now become. I also feel that the NiteNob should be a mandatory feature for all multiple family dwellings.
